(19) United States
(12) Patent Application Publication
(10) Pub. No.: US 2025/0139253 A1
(43) Pub. Date: May 1, 2025

(54) AUTOMATED AND SECURE PRODUCTION DATA FLOW

(71) Applicant: Honeywell International Inc., Charlotte, NC (US)

(72) Inventors: Mark Alan Keith, Valrico, FL (US); Milos Machat, Slatina (CZ)

(21) Appl. No.: 18/498,617

(22) Filed: Oct. 31, 2023

(51) Int. Cl. G06F 21/57; G06F 21/55; G06F 21/60

(52) U.S. Cl. CPC G06F 21/577; G06F 21/552; G06F 21/602

(57) ABSTRACT

Embodiments described herein provide methods for secure and automated production data flow for an enterprise-level production environment. Embodiments are configured to generate, by a production management system (PMS), first visual indicia associated with testing operation data. Embodiments are also configured to cause display of the first visual indicia, where the first visual indicia are configured to be decoded by a scanning device of an isolated system (IDS). Embodiments are also configured to decode a second visual indicia rendered by the IDS, where the second visual indicia are associated with a testing data input summary generated by the IDS based on data decoded from the first visual indicia. Embodiments are also configured to generate a third visual indicia associated with a testing data confirmation associated with the testing data input summary, where decoding of the third visual indicia is configured to cause execution of multiple testing operations by the IDS.

### TECHNICAL FIELD

The present disclosure relates generally to industrial production environments, and more particularly to secure and automated data transfer for production management systems.

### BACKGROUND

Conventional production management systems associated with enterprise-level production environments often rely on manual human input and/or manual human interactions during the mass production of one or more products, computing devices, component parts, and/or the like. Additionally, conventional production management systems may also require manual human input and/or manual human interactions during the execution of pre-production unit testing operations. As such, human entry errors and/or delays may be introduced into the production flow. Furthermore, conventional production management systems are vulnerable to outside interference such as cyberattacks and/or cybertheft. Inventors have discovered problems with current implementations of production management systems as well as unit testing techniques. Through applied effort, ingenuity, and innovation, the inventors have solved many of these problems by developing the solutions embodied in the present disclosure, the details of which are described further herein.

### BRIEF SUMMARY

In general, embodiments of the present disclosure herein provide secure and automated production data flow. Other implementations will be, or will become, apparent to one with skill in the art upon examination of the following figures and detailed description. It is intended that all such additional implementations be included within this description be within the scope of the disclosure and be protected within the scope of the following claims.

In accordance with a first aspect of the present disclosure, a computer-implemented method for providing secure and automated production data flow is provided. The computer-implemented method is performable by one or more specially configured computing device(s) embodied in hardware, software, firmware, and/or any combination thereof, for example as described herein. In one example embodiment, the example computer-implemented method includes generating, by a mobile computing device associated with a production management system (PMS) associated with a first network, at least one first visual indicia associated with one or more portions of testing operation data, where the at least one first visual indicia is configured to be displayed via a user interface associated with the mobile computing device. The example computer-implemented method also includes causing display of the at least one first visual indicia via the user interface, where the at least one first visual indicia is configured to be decoded by a scanning device of an isolated diagnostic system (IDS) associated with an isolated network. The example computer-implemented method also includes decoding a second visual indicia rendered by the IDS, where the second visual indicia is associated with a testing data input summary generated by the IDS based on data decoded from the one or more first visual indicia. The example computer-implemented method also includes generating a third visual indicia associated with a testing data confirmation associated with the testing data input summary. The example computer-implemented method also includes causing display of the third visual indicia via the user interface, where decoding of the third visual indicia is configured to cause execution of one or more testing operations by the IDS.

The example computer-implemented method further includes decoding a fourth visual indicia rendered by the IDS, where the fourth visual indicia is associated with one or more first portions of testing result data generated by the IDS based on the one or more testing operations, and where each portion of the one or more first portions of testing result data is indicated as a key performance characteristic by a classification model of the IDS. The example computer-implemented method also includes causing, in response to decoding the fourth visual indicia, storage of the one or more first portions of testing result data in a datastore associated with the PMS.

The example computer-implemented method further includes where at least one or more of the at least one first visual indicia, the second visual indicia, the third visual indicia, or the fourth visual indicia are configured as at least one of a quick response (QR) code, a barcode, or a data matrix code.

The example computer-implemented method further includes receiving, during one or more predetermined network connectivity windows, one or more portions of secondary testing result data generated by the IDS based on the one or more testing operations. The example computer-implemented method also includes causing storage of the one or more portions of secondary testing result data in the datastore associated with the PMS after receiving the one or more portions of secondary testing result data from the IDS during the one or more predetermined network connectivity windows.

The example computer-implemented method further includes where the one or more portions of secondary testing result data are encrypted by the IDS.

The example computer-implemented method further includes where the one or more predetermined network connectivity windows are associated with a temporary network connection between the first network associated with the PMS and the IDS, and where the one or more predetermined network connectivity windows are associated with a predefined transmission duration.

The example computer-implemented method further includes where the IDS is configured to determine at least one or more of a transmission progress, a transmission success, or a transmission failure associated with the one or more portions of secondary testing result data transmitted to the PMS during the one or more predetermined network connectivity windows.

The example computer-implemented method further includes where generating the third visual indicia further comprises determining a data validity and a data freshness of one or more portions of data associated with the testing data input summary associated with the second visual indicia. The example computer-implemented method also includes, in response to determining the data validity and the data freshness of one or more portions of data associated with the testing data input summary, generating the third visual indicia associated with the testing data confirmation.

The example computer-implemented method further includes where the one or more portions of testing operation data comprises at least one or more of product data, machine data, environment data, or at least one testing operation associated with a unit under test (UUT) related to the PMS.

In accordance with a second aspect of the disclosure, a computer program product for providing secure and automated production data flow is provided. In one example embodiment computer program product, the computer program product includes at least one non-transitory computer-readable storage medium having computer program code stored thereon that, in execution with at least one processor, configures the computer program product for performing any one of the example computer-implemented methods described herein.

In accordance with a third aspect of the disclosure, an apparatus for providing secure and automated production data flow is provided. In one example embodiment, the apparatus includes at least one processor and at least one memory having computer-coded instructions stored thereon, where the computer-coded instructions in execution with the at least one processor causes the apparatus to perform any one of the example computer-implemented methods described herein. In a second example embodiment apparatus, the apparatus includes means for performing each step of any one of the example computer-implemented methods described herein.

In accordance with a fourth aspect of the present disclosure, a computer-implemented method for configuring a PMS application instance associated with a PMS is provided. The computer-implemented method is performable by one or more specially configured computing device(s) embodied in hardware, software, firmware, and/or any combination thereof, for example as described herein. In one example embodiment, the example computer-implemented method includes determining, for a mobile computing device, one or more configuration parameters associated with an application instance related to a production management system (PMS), where the one or more configuration parameters are determined based at least in part on one or more of location data or network status data associated with the mobile computing device. The example computer-implemented method also includes determining, based at least in part on the one or more configuration parameters, a user interface display theme. The example computer-implemented method also includes determining, based at least in part on the one or more configuration parameters, at least one application instance access permission. The example computer-implemented method also includes applying the user interface display theme to a user interface associated with the application instance. The example computer-implemented method also includes toggling, based at least in part on the at least one application instance access permission, at least one application instance functionality associated with the application instance.

The example computer-implemented method further includes where the user interface display theme is associated with at least one or more sports teams associated with a particular location of the mobile computing device, live events associated with the particular location of the mobile computing device, or an organization associated with the mobile computing device.

The example computer-implemented method further includes where applying the user interface display theme to the user interface further comprises updating at least one or more color schemes, banners, graphics, icons, images, image contents, sound effects, button graphics, button layouts, text fonts, text formats, hyperlinks, or hyperlink addresses associated with the user interface.

The example computer-implemented method further includes where toggling the at least one application instance functionality further comprises determining, based at least in part on the network status data, whether the mobile computing device is connected to a trusted network or an untrusted network. The example computer-implemented method also includes, in response to determining the mobile computing device is connected to a trusted network, enabling the at least one application instance functionality associated with the application instance. The example computer-implemented method also includes, in response to determining the mobile computing device is connected to an untrusted network, disabling the at least one application instance functionality associated with the application instance.

The example computer-implemented method also includes where the user interface display theme is updated based at least in part on whether the mobile computing device is connected to the trusted network or the untrusted network.

In accordance with a fifth aspect of the disclosure, a computer program product for configuring a PMS application instance associated with a PMS is provided. In one example embodiment computer program product, the computer program product includes at least one non-transitory computer-readable storage medium having computer program code stored thereon that, in execution with at least one processor, configures the computer program product for performing any one of the example computer-implemented methods described herein.

In accordance with a sixth aspect of the disclosure, an apparatus for configuring a PMS application instance associated with a PMS is provided. In one example embodiment, the apparatus includes at least one processor and at least one memory having computer-coded instructions stored thereon, where the computer-coded instructions in execution with the at least one processor causes the apparatus to perform any one of the example computer-implemented methods described herein. In a yet another example embodiment apparatus, the apparatus includes means for performing each step of any one of the example computer-implemented methods described herein.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE SEVERAL VIEWS OF THE DRAWINGS

The description of the illustrative embodiments can be read in conjunction with the accompanying figures. It will be appreciated that for simplicity and clarity of illustration, elements illustrated in the figures have not necessarily been drawn to scale. To easily identify the discussion of any particular element or act, the most significant digit or digits in a reference number refer to the figure number in which that element is first introduced.

FIG. 1 illustrates an example environment that enables secure and automated production data flow in accordance with at least some example embodiments of the present disclosure.

FIG. 2 illustrates an example isolated diagnostic system (IDS) computing device in accordance with at least some example embodiments of the present disclosure.

FIG. 3 illustrates an example production management system (PMS) computing device in accordance with at least some example embodiments of the present disclosure.

FIG. 4 illustrates an example data flow related to a testing operation associated with a unit under test (UUT) facilitated by an IDS and a PMS in accordance with at least some example embodiments of the present disclosure.

FIG. 5 illustrates an example data flow related to the transmission of testing result data from an IDS to a PMS during respective predetermined network connectivity windows in accordance with at least some example embodiments of the present disclosure.

FIG. 6 illustrates a flowchart depicting example operations of an example process for executing a testing operation associated with a UUT facilitated by an IDS and a PMS in accordance with at least some example embodiments of the present disclosure.

FIG. 7 illustrates a flowchart depicting example operations of an example process for configuring a PMS application instance associated with a PMS on a PMS computing device in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### OVERVIEW

Various production management systems associated with enterprise-level production environments often require manual human interactions and/or manual data entry to configure and manage the flow of production. Furthermore, some production management systems may also require manual human interactions and/or manual data entry to configure and execute quality control and/or testing procedures related to the products being developed by the enterprise associated with the production management system. As such, various production systems associated with enterprise-level production environments can be negatively impacted by human error. Such human error may lead to production delays, quality control inadequacies, and/or inefficient production flow.

Furthermore, various production management systems face any of a myriad of cybersecurity related risks and vulnerabilities. For example, such systems are often inadequately secured against outside interference such as cyberattacks, cybertheft, and/or other cybersecurity risks. The inherent security vulnerabilities in these production management systems can lead to intellectual property loss, production loss, production delays, and/or system failures. Embodiments of the present disclosure are configured to address these limitations and the like.

Embodiments of the present disclosure provide methods, systems, computer program products, and apparatuses configured to provide both secure and automated production data flow for a plurality of production environments. For example, embodiments described herein provide an isolated diagnostic system (IDS) and a production management system (PMS) configured to work in tandem to provide secure and automated production data flow related to the processes, testing, diagnostics, and/or quality control of various products being developed in a respective production environment.

An IDS is a model-driven system for testing, predicting, modeling, forecasting, demonstrating, and/or estimating the performance, functioning, behavior, and/or operation of one or more UUTs within a particular environment and/or set of constraints. An IDS is configured to be secured from outside interference (e.g., cyberattacks) by being isolated from any outside communications networks, such as by having no physical and/or wireless network connections to any outside communications networks (e.g., public wide area networks (WANs) and/or local area networks (LANs) in some contexts). As such, an IDS can securely perform one or more testing operations associated with a particular UUT without being susceptible to outside threats. Furthermore, the IDS is configured to generate one or more visual indicia (e.g., quick response (QR) codes, barcodes, and/or the like as described herein) comprising any critically important testing result data that can be scanned and/or decoded by a computing device associated with a respective PMS. This type of secure production data flow can be performed without the IDS and PMS being connected to a common communications network.

A PMS is a system comprising one or more hardware and/or software components configured to facilitate and/or assist the production, testing, diagnostic, quality control, and/or development operations of a particular enterprise-level production environment. The PMS is configured to retrieve, compile, and/or organize testing operation data associated with a particular UUT and generate one or more visual indicia associated with the testing operation data. The one or more visual indicia can be scanned and/or decoded by an IDS scanning device, such that the IDS can, via the scan of the one or more visual indicia, receive, process, and execute one or more testing operations associated the UUT.

To facilitate the configuration and execution of testing operations associated with one or more UUTs, embodiments herein provide a PMS application instance that can be employed by a PMS computing device (e.g., a mobile computing device, smartphone, and/or the like). The PMS application instance is configured to facilitate the generation and transmission of testing operation data associated with a respective UUT to the IDS, for example via the generation of particular visual indica. The PMS application instance is also configured to verify that the IDS has successfully received and configured one or more testing operations associated with the UUT. For example, the PMS application instance may be configured to facilitate the scanning and/or decoding of visual indicia generated by the IDS associated with a testing data input summary to verify the validity and freshness of the testing operation data. The employment of the PMS application instance to facilitate the configuration and execution of testing operations by the IDS ensures the security, precision, and automation of said testing operations using such visual indicia. The employment of the PMS application instance also provides the technical benefit of increasing production speed, quality, and efficiency while mitigating the negative impacts of human error using such visual indicia.

Furthermore, various embodiments provided herein are constructed to determine configuration parameters associated with the PMS application instance based at least in part on location data and/or network status data processed by a mobile computing device associated with the PMS application instance. Based on the configuration parameters, a user interface display theme and/or one or more application instance access permissions can be applied to the PMS application instance. For example, a user interface display theme may be applied to a user interface associated with the PMS application instance based on a real-world location of the mobile computing device associated with the PMS application instance. In various examples, the user interface display theme may be associated with one or more sports teams associated with the particular location of the mobile computing device, live events associated with the particular location of the mobile computing device, or an organization associated with the mobile computing device. Additionally, one or more application instance functionalities associated with the PMS application instance may be enabled or disabled based at least in part on whether the mobile computing device associated with the PMS application instance is connected to a trusted network or an untrusted network. Such embodiments customize configuration of the application instances and/or improve security of the overall system based on the specifically-derived configuration parameters and/or data for an application instance or PMS application instance.

### Definitions

“Isolated diagnostic system (IDS)” refers to combination of hardware and/or software components that are configured to perform, implement, execute, assist, facilitate, monitor, and/or otherwise manage the operational testing of one or more units under test (UUTs) associated with an enterprise-level production environment. In various embodiments, an IDS is a model-driven system for testing, predicting, modeling, forecasting, demonstrating, and/or estimating the performance, functioning, behavior, and/or operation of a UUT within a particular environment and/or set of constraints. As such, an IDS may be configured to receive and/or process one or more portions of testing operation data related to a particular UUT to conduct one or more tests, experiments, measurements, predictions, modellings, observations, and/or analyses of the operation of the particular UUT within the particular environment and/or set of constraints. In this regard, an IDS may generate one or more portions of testing result data based on the one or more tests, experiments, measurements, predictions, modellings, observations, and/or analyses of a particular UUT.

An IDS is configured to be secured from outside interference by being isolated from any outside communications networks. For example, an IDS may comprise an internal isolated network for facilitating the communication of the various components of the IDS while remaining disconnected from any public and/or private networks. In this regard, an IDS may be configured to safely transmit and/or receive data such as, for example, testing operation data, testing result data, and/or the like, by generating and/or decoding visual indicia. For example, an IDS may transmit data to and/or receive data from a production management system (PMS) through the generation and/or decoding of visual indicia without relying on a communications network. Additionally or alternatively, in some contexts, an IDS may be configured to transmit testing result data and/or other data to a PMS via a common network during a predetermined network connectivity window.

“Production management system (PMS)” refers to a system comprising one or more hardware and/or software components configured to facilitate and/or assist the production, testing, diagnostic, quality control, and/or development operations of a particular enterprise-level production environment. A particular PMS may comprise and/or be integrated with one or more computing devices, UUTs, and/or datastores related to a particular enterprise. In some examples, a PMS may be a sub-system of a larger enterprise-level production system. In various examples, a PMS may be associated with a particular type of enterprise entity, facility, or vehicle, such as, for example, a particular company, division, building, manufacturing plant, warehouse, laboratory, oil and gas facility, chemical facility, aircraft, spacecraft, automobile, ship, boat, military vehicle, or any other type of enterprise entity, facility, and/or vehicle that include any number of local devices.

Additionally or alternatively, in various examples, a PMS may be related to one or more enterprise technologies, such as, for example, aerospace technologies, vehicle technologies, industrial technologies, connected building technologies, Internet of Things (IoT) technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, automobile technologies, cybersecurity technologies, navigation technologies, asset visualization technologies, oil and gas technologies, petrochemical technologies, refinery technologies, process plant technologies, procurement technologies, and/or one or more other technologies.

“Predetermined network connectivity window” refers to a temporary network connection between an IDS and a PMS. By employing predetermined network connectivity windows, an IDS can remain secure against outside cyberthreats by ensuring that the IDS only transmits data to a PMS via a common network during a short, pre-scheduled amount of time. In various examples, a predetermined network connectivity window may be associated with a predefined transmission duration (e.g., a transmission duration of one minute). Furthermore, a predetermined network connectivity window may be associated with a network connectivity schedule. For example, a predetermined network connectivity window may have a predefined transmission duration of one minute and may be scheduled to occur only once during a twenty-four-hour period.

“PMS application instance” refers to a software application instance associated with a particular PMS. In various examples, a PMS computing device associated with a PMS may be configured to generate, render, and/or employ a PMS application instance associated with the PMS that is configured to execute one or more commands, processes, methods, and/or techniques described herein. A PMS application instance may be configured to facilitate (e.g., configure and/or initiate) the execution of one or more testing operations associated with one or more UUTs by the IDS. For example, a PMS application instance may be employed to facilitate the scanning and/or decoding of one or more visual indicia generated by an IDS (e.g., visual indicia associated with testing result data). As another example, a PMS application instance may be employed to generate one or more visual indicia associated with one or more UUTs, for example visual indicia associated with testing operation data. The one or more visual indicia are configured to be rendered via the PMS application instance on an electronic display associated with the PMS computing device.

In various embodiments, a PMS application instance may be associated with a set of configuration parameters. In some examples, the set of configuration parameters may be determined based on at least one of location data and/or network status data associated with the PMS computing device. Based on the configuration parameters, a user interface display theme may be determined and/or applied to a user interface associated with the PMS application instance. Additionally or alternatively, based on the set of configuration parameters, one or more application instance access permissions associated with one or more respective application instance functionalities may be granted or restricted.

“Visual indicia” refers to various data-encoded indicia, graphics, tokens, and/or symbols that are configured to be scanned and/or decoded by a scanning device, mobile computing device, and/or the like. In various examples, visual indicia may comprise one or more portions of data related to an IDS, a PMS, and/or various UUTs such as, for example, testing operation data, testing result data, and/or the like. Examples of visual indicia include, but are not limited to, QR codes, barcodes, or data matrix codes.

“IDS classification model” refers to machine learning (ML) model that may be configured to classify, process, analyze, quantify, qualify, capture, encode, decode and/or otherwise manage data generated and/or received by an IDS computing device. Non-limiting examples of the data processed by an IDS classification model includes testing result data, testing operation data, and/or the like. In certain embodiments, an IDS classification model may comprise, employ, direct, and/or otherwise integrate with one or more deep learning neural networks such as an artificial neural network (ANN), convolutional neural network (CNN), recurrent neural network (RNN), or any other type of specially trained neural network that is configured to classify and/or process data generated by an IDS computing device (e.g., testing result data, testing operation data, and/or the like). Additionally or alternatively, an IDS classification model may support a variety of different analytics models including, for example, first principles models, empirical models, engineered models, user-defined models, ML models, artificial intelligence (AI) models, built-in functions, and/or any other types of analytics models. Classification and predictive models will be described herein by way of example, but any type of models may be applicable.

“Unit under test (UUT)” refers to a particular hardware component, software component, or a combination thereof associated with an enterprise-level production environment associated with the PMS and the IDS. For example, a UUT may be an aerospace gateway computing device configured as a line replaceable unit (LRU) constructed to be compatible with one or more aerial vehicles. As another example, in some embodiments a UUT is a discrete portion of executable program code, a software application, and/or other instructions. In some embodiments the UUT is under development by an enterprise associated with the PMS.

“Testing operation data” refers to one or more portions of testing configuration data associated with a particular UUT. In various examples, testing operation data may be generated, compiled, organized, structured, parsed, stored, and/or otherwise managed by a PMS. In various examples, a PMS computing device associated with a PMS may be configured to generate one or more visual indicia associated with various portions of testing operation data. As such, the one or more visual indicia associated with the testing operation data may be scanned and/or decoded by an IDS scanning device such that an IDS computing device may receive and subsequently process the testing operation data. In some embodiments, testing operation data may comprise product data, machine data, environment data, and/or operation data related to a particular UUT and/or a testing operation related to the particular UUT.

“Testing result data” refers to the data generated by an IDS computing device as a result of executing one or more testing operations associated with a particular UUT. In various examples, the one or more portions of testing result data may be configured in various formats such as, for example, one or more visual indicia, electronically managed data objects, JSON data objects, and/or any data formatted in a manner that can be processed, stored, managed, and/or otherwise utilized by a computing device. In various examples, an IDS classification model may be employed to classify testing result data generated by the IDS computing device.

For example, the IDS classification model may classify one or more portions of testing result data as being KPC(s). In general, KPCs are portions of testing result data that are deemed to be the most relevant, pertinent, important, and/or critical with regards to the performance of the UUT based on one or more testing operations. KPCs may or may not be associated with the expected results of a particular testing operation. For example, in various contexts, one or more KPCs may be associated with “out-of-family” data generated during the testing operations, where the out-of-family data may represent statistical outliers, anomalies, and/or unexpected behavior. In this regard, KPCs may represent both favorable and unfavorable outcomes related to one or more testing operations associated with a particular UUT and are therefore considered critical pieces of testing result data.

As another example, the IDS classification model may classify one or more portions of testing result data as being SPC(s). In general, SPCs are portions of data related to the process associated with the execution of the one or more testing operations that are generated or gathered during the execution of one or more testing operations. SPCs may be samples of data extracted during the execution of the one or more testing operations that indicate variations in the quality of the testing being executed with regard to a particular UUT, variations in performance of the UUT during the one or more testing operations, and/or variations in the output of the testing result data. Based on one or more SPCs, it may be determined that at least one of a configuration of the UUT, a configuration of the testing operation data, and/or a configuration of the IDS needs to be updated, revised, and/or reconfigured to ensure the quality control of the UUT, the testing operations, and/or the IDS.

“Computing device” refers to any computer, processor, circuitry, and/or other executor of computer instructions that is embodied in hardware, software, firmware, and/or any combination thereof. Non-limiting examples of a computing device include a computer, a processor, an application-specific integrated circuit, a field-programmable gate array, a personal computer, a smartphone, a laptop, a tablet computer, a fixed terminal, a server, a networking device, and/or a virtual machine. In various examples, a computing device may be associated with a person, company, or other organizational structure that controls one or more systems. In some embodiments, a user computing device is associated with particular administrative credentials that define access to operation via a particular system.

“Executable program code” refers to a portion of computer program code stored in one or a plurality of locations that is executed and/or executable via one or more computing devices embodied in hardware, software, firmware, and/or any combination thereof. Executable code defines at least one particular operation to be executed by one or more computing devices. In some embodiments, a memory, storage, and/or other computing device includes and/or otherwise is structured to define any amount of executable code (e.g., a portion of executable code associated with a first operation and a portion of executable code associated with a second operation). Additionally or alternatively, in some embodiments, executable code is embodied by separate computing devices (e.g., a first datastore embodying first portion of executable code and a second datastore embodying a second portion executable code).

“Datastore,” “database,” and “data lake” refer to any type of non-transitory computer-readable storage medium. Non-limiting examples of a datastore, database, and/or data lake include hardware, software, firmware, and/or a combination thereof capable of storing, recording, updating, retrieving and/or deleting computer-readable data and information. In various embodiments, a datastore, database, and/or data lake in some contexts is a cloud-based storage system accessible via a communications network by one or more components of the various embodiments of the present disclosure.

“Data attribute” refers to electronically managed data representing a variable or particular criteria or property having a particular value or status. In some contexts, the value is statically fixed or dynamically assigned. In some embodiments, a data attribute embodies a particular property of a data object.

“Data value” refers to electronically managed data representing a particular value for a particular data attribute, operational parameter, sensor device, and/or the like.

The phrases “in an embodiment,” “in one embodiment,” “according to one embodiment,” and the like generally mean that the particular feature, structure, or characteristic following the phrase in some contexts is included in at least one embodiment of the present disclosure, and in some contexts is included in more than one embodiment of the present disclosure (importantly, such phrases do not necessarily refer to the same embodiment). The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature in some contexts is optionally included in some embodiments, or it in some contexts is excluded.

As used herein, the terms “data,” “content,” “digital content,” “data object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

EXAMPLE SYSTEMS AND APPARATUSES OF THE DISCLOSURE

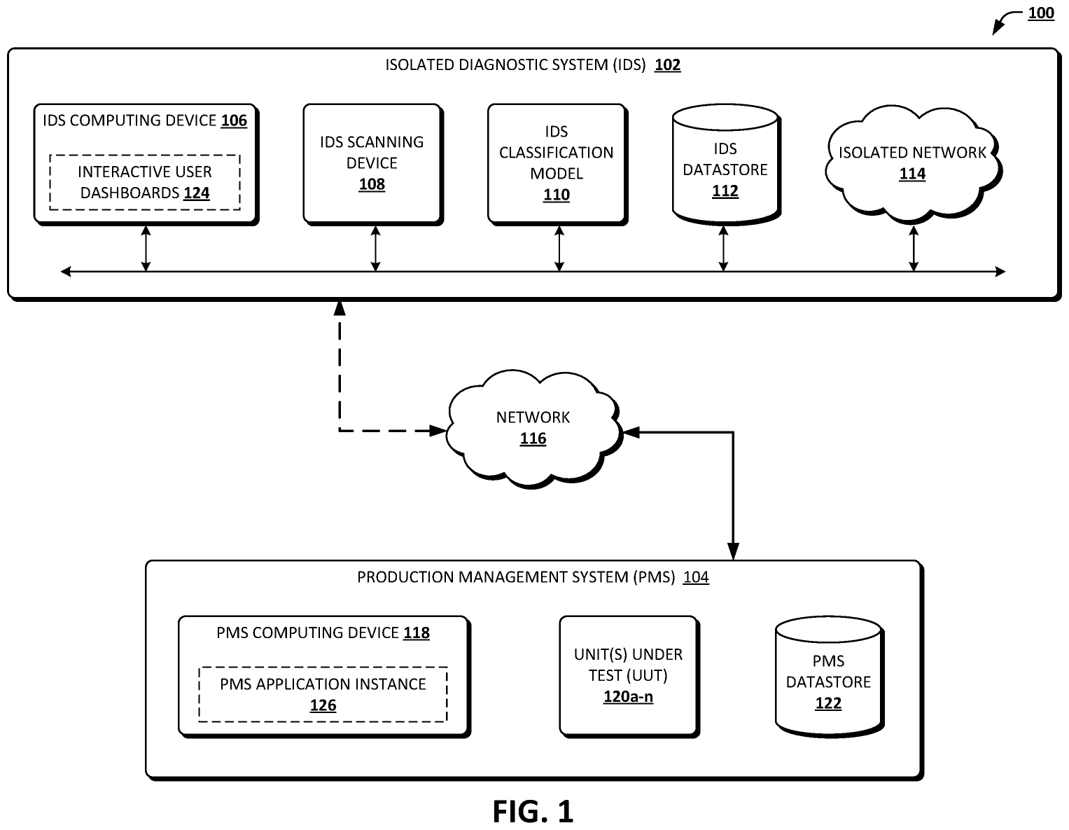

FIG. 1 illustrates an example environment that enables secure and automated production data flow in accordance with at least some example embodiments of the present disclosure. Specifically, FIG. 1 depicts an example environment 100 (e.g., an example enterprise-level production environment) within which embodiments of the present disclosure may operate to provide secure and automated production data flow between an isolated diagnostic system (IDS) 102 and a production management system (PMS) 104.

The IDS 102 may be configured to perform, implement, execute, assist, facilitate, monitor, and/or otherwise manage the operational testing of one or more units under test (UUTs) 120a-n associated with an enterprise-level production environment. In various embodiments, the IDS 102 is a model-driven system for testing, predicting, modeling, forecasting, demonstrating, and/or estimating the performance, functioning, behavior, and/or operation of a UUT 120a within a particular environment and/or set of constraints. As such, the IDS 102 may be configured to receive and/or process one or more portions of testing operation data related to a particular UUT 120a to conduct one or more tests, experiments, measurements, predictions, modellings, observations, and/or analyses of the operation of the particular UUT 120a within the particular environment and/or set of constraints.

In this regard, the IDS 102 may generate one or more portions of testing result data based on the one or more tests, experiments, measurements, predictions, modellings, observations, and/or analyses of a particular UUT 120a. In various examples, the one or more portions of testing result data may be configured in various formats such as, for example, one or more visual indicia (e.g., quick response (QR) codes), electronically managed data objects (e.g., JSON formatted data objects), and/or any data format that can be processed, stored, managed, and/or otherwise utilized by a computing device.

In one or more embodiments, an IDS 102 may comprise an IDS classification model 110 that is configured to classify the one or more portions of testing result data. For example, an IDS classification model 110 may be configured to determine whether one or more portions of testing result data are to be classified as key performance characteristics (KPCs) or statistical process characteristics (SPCs). In various examples, an IDS 102 may configure one or more portions of testing result data in a particular format based on a respective classification assigned to the one or more portions of testing result data by the IDS classification model 110.

The IDS 102 is configured to be secure from outside interference (e.g., cyberattacks) by being isolated from any outside communications networks. For example, an IDS may comprise an isolated network 114 for facilitating the communication of the various components of the IDS 102 while remaining disconnected from any public and/or private networks (e.g., a local area network (LAN), or wide area network (WAN)). In this regard, the IDS 102 may be configured to safely transmit and/or receive data (e.g., testing operation data, testing result data, and/or the like) by generating and/or decoding visual indicia. For example, the IDS 102 may transmit data to and/or receive data from the PMS 104 through the generation and/or decoding of visual indicia without relying on a communications network. Additionally or alternatively, in some contexts, the IDS 102 may be configured to transmit data (e.g., testing result data) to the PMS 104 via a common network (e.g., a wireless LAN) during a predetermined network connectivity window.

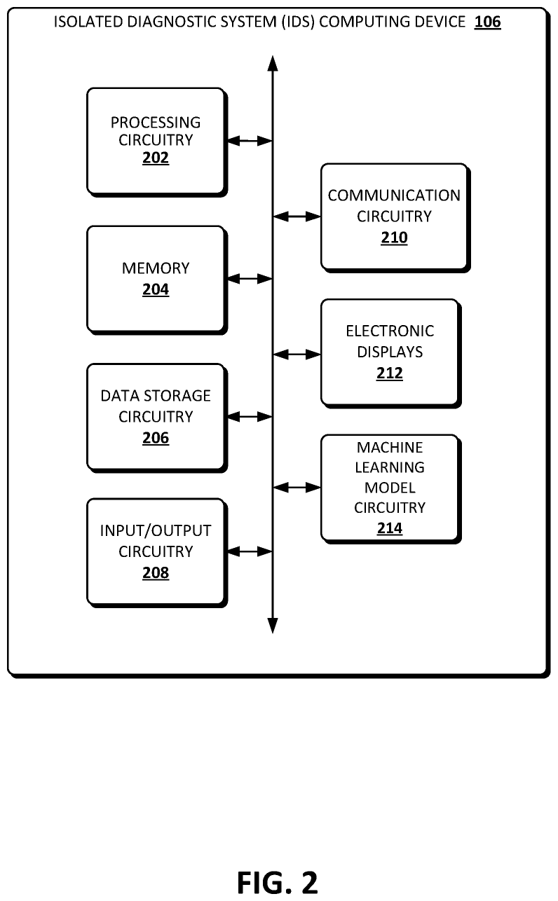

As shown in FIG. 1, the IDS 102 comprises an IDS computing device 106, an IDS scanning device 108, an IDS classification model 110, an IDS datastore 112, and/or an isolated network 114. In some embodiments, the IDS computing device 106 includes, embodies, and/or integrates with one or more computing devices, application servers, end user terminals, personal computers, mobile devices, user devices, and/or the like that are embodied in hardware, software, firmware, and/or a combination thereof, the details of which will be further discussed with reference to FIG. 2.

In various examples, the IDS computing device 106 may configured to embody, employ, direct, control, and/or otherwise manage one or more testing and/or diagnostic systems associated with the IDS 102. In some examples, the one or more testing and/or diagnostic systems may be associated with one or more computing devices embedded in a combination of hardware, software, and/or firmware components configured to execute one or more testing operations related to one or more UUTs 120a-n. Additionally or alternatively, in some examples, the one or more testing and/or diagnostic systems may be associated with one or more virtual machines configured to execute one or more testing operations related to one or more UUTs 120a-n. Furthermore, in some embodiments, the IDS computing device 106 may be configured to employ one or more third-party testing and/or diagnostic systems and/or third-party testing software applications.

As shown in FIG. 1, the IDS computing device 106 is configured to generate, render, and/or cause display of one or more interactive user dashboards 124 associated with one or more portions of data related to the IDS 102 (e.g., testing operation data, testing result data, KPC data, SPC data, data related to one or more UUTs 120a-n, and/or the like). For example, the IDS computing device 106 may be configured to generate, render, and/or cause display of one or more interactive user dashboards 124 configured as a utilization dashboard and/or a production dashboard. The data comprised in the one or more interactive user dashboards 124 may be stored and/or managed by the IDS datastore 112.

An interactive user dashboard 124 configured as a utilization dashboard may be configured to display various interactive sub-interfaces (e.g., user interfaces). In one or more examples, the various sub-interfaces may comprise one or more interactive data tables and/or interactive graphs associated with one or more statistics that are relevant to the testing operations performed by the IDS 102. For example, a utilization dashboard may be configured to display various portions of testing result data classified by the IDS classification model 110 as SPCs. Additionally or alternatively, a utilization dashboard may be configured to display one or more interactive data tables and/or graphs associated with various production performances, process performances, testing and/or diagnostic system performances, and/or operator performances.

A production performance may be associated with a predetermined production time period (e.g., one week), any may detail a rolled throughput yield (RTY) and/or a production throughput associated with the enterprise associated with the IDS 102. The RTY may pertain to a process performance measure that provides insight into the cumulative effects of an entire production process. In some examples, the RTY may measure a yield for each of several productions process steps and provide a probability that a UUT 120a will come through said production process free of defects, malfunctions, and/or errors.

A process performance may be related to one or more testing operations executed by the IDS computing device 106 and may detail a first pass yield (FPY) that indicates a production and/or quality performance of a particular production line. A testing and/or diagnostic system performance may comprise one or more of identification data associated with one or more respective testing and/or diagnostic systems, utilization percentages associated with the one or more respective testing and/or diagnostic systems, and/or an FPY associated with the one or more respective testing and/or diagnostic systems. An operator performance may comprise one or more of operator identification data, a number of testing operations and/or testing iterations initiated by one or more respective operators, and/or an FPY associated with the one or more respective operators.

An interactive user dashboard 124 configured as a production dashboard may be configured to display one or more sub-interfaces. In one or more examples, the various sub-interfaces may comprise one or more interactive data tables and/or interactive graphs associated with one or more statistics that are associated with an immediate production status related to the enterprise associated with the IDS 102 and the PMS 104.

In various embodiments, an interactive user dashboard 124 configured as a production dashboard may be configured to display data related to one or more testing and/or diagnostic systems associated with the IDS 102 including, but not limited to, a system status, a system calibration execution date, a system self-test execution date, a system operator, one or more testing procedures, a UUT serial number, a testing operation status, a testing operation duration, and/or a remaining time associated with a testing operation.

As shown in FIG. 1, the IDS computing device 106 may also be configured to embody, integrate with, and/or otherwise be in communication with the IDS scanning device 108. The IDS scanning device 108 may be any device configured to scan and/or decode one or more types of visual indicia. For example, the IDS scanning device 108 may be configured to scan and/or decode one or more of a QR code, a barcode, a data matrix code, and/or the like. Furthermore, the IDS scanning device 108 may be configured to scan one or more types of visual indicia rendered on an electronic display associated with a PMS computing device 118. As such, the IDS computing device 106 may be able to, via the IDS scanning device 108, receive one or more portions of data that are encoded in one or more QR codes associated with, for example, testing operation data related to a particular UUT 120a.

In various embodiments, the IDS 102 may comprise an IDS classification model 110. The IDS classification model 110 may be a machine learning (ML) model that may be configured to classify, process, analyze, quantify, qualify, capture, encode, decode and/or otherwise manage data generated and/or received by an IDS computing device 106 (e.g., testing result data, testing operation data, and/or the like). In certain embodiments, an IDS classification model 110 may comprise, employ, direct, and/or otherwise integrate with one or more deep learning neural networks such as an artificial neural network (ANN), convolutional neural network (CNN), recurrent neural network (RNN), or any other type of specially trained neural network that is configured to classify and/or process data generated by an IDS computing device 106 (e.g., testing result data, testing operation data, and/or the like).

In some embodiments, the IDS 102 may also comprise an IDS datastore 112. The IDS datastore 112 may include hardware, software, firmware, and/or a combination thereof capable of storing, recording, updating, retrieving and/or deleting computer-readable data and information related to the IDS 102. For example, the IDS datastore 112, in some contexts, stores testing operation data, testing result data, visual indicia data, and/or one or more portions of training data for training and/or re-training the various models associated with the IDS 102 (e.g., the IDS classification model). In some contexts, the IDS datastore 112 can be accessible via a communications network (e.g., the isolated network 114) by one or more components of the various embodiments of the present disclosure.

In various embodiments, the isolated network 114 may be a private network configured to facilitate the communications of the various components of the IDS 102. In some examples, the isolated network 114 is intentionally isolated from one or more outside networks (e.g., the network 116) that are capable of connecting to one or more public networks and/or domains. This intentional isolation from outside networks ensures the security of the testing operations executed by the IDS computing device 106 and the testing result data generated therefrom.

As depicted in FIG. 1, the example environment 100 further includes the PMS 104. As described herein, the PMS 104 may be configured to facilitate and/or assist the production, testing, quality control, and/or development operations of a particular enterprise-level production environment. The PMS 104 may comprise and/or integrate with one or more computing devices (e.g., a PMS computing device 118), UUTs 120a-n, and/or datastores (e.g., a PMS datastore 122) related to a particular enterprise. As shown in FIG. 1, in one or more embodiments, the PMS 104 comprises a PMS computing device 118, one or more units under test (UUTs) 120a-n, and/or a PMS datastore 122.

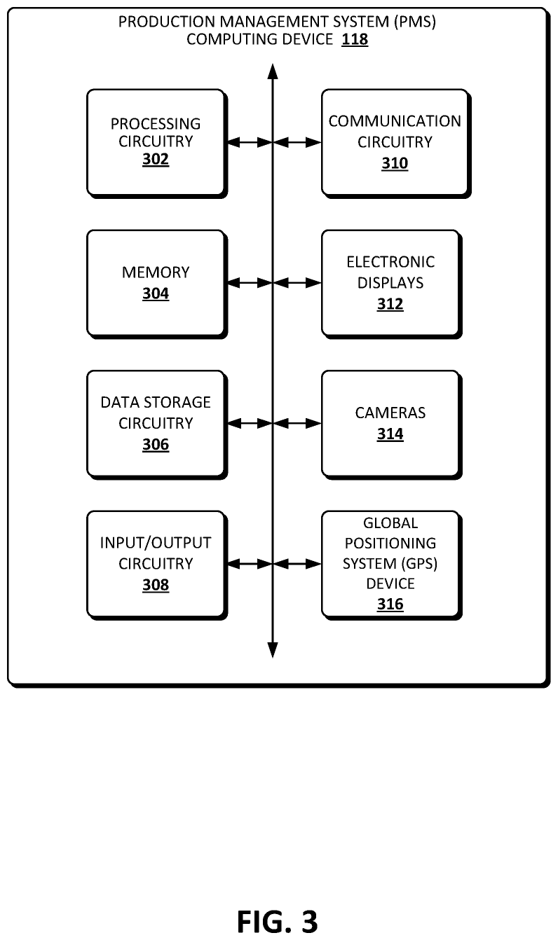

In some embodiments, the PMS computing device 118 includes, embodies, and/or integrates with one or more mobile computing devices, personal computers, user devices, smartphones, tablet computers, laptops, and/or the like that are embodied in hardware, software, firmware, and/or a combination thereof, the details of which will be further discussed with reference to FIG. 3. In various examples, a PMS computing device 118 associated with a PMS 104 may be configured to generate, render, and/or employ a PMS application instance 126 associated with the PMS 104 that is configured to execute one or more commands, processes, methods, and/or techniques described herein. A PMS application instance 126 may be configured to facilitate (e.g., configure and/or initiate) the execution of one or more testing operations associated with one or more UUTs 120a-n by the IDS 102. For example, a PMS application instance 126 may be employed to generate one or more visual indicia associated with one or more UUTs 120a-n (e.g., visual indicia associated with testing operation data) that are configured to be rendered via the PMS application instance 126 on an electronic display associated with the PMS computing device 118. As another example, a PMS application instance 126 may be employed to facilitate the scanning and/or decoding of one or more visual indicia generated by an IDS 102 (e.g., visual indicia associated with testing result data).

A particular PMS application instance 126 may be associated with a respective set of configuration parameters. In some examples, the set of configuration parameters may be determined based on at least one of location data and/or network status data associated with the PMS computing device 118 associated with the particular PMS application instance 126. Based on the configuration parameters, a user interface display theme may be determined and/or applied to a user interface associated with the PMS application instance 126. In various examples, the user interface display theme may be associated with at least one or more sports teams associated with a particular location of the PMS computing device 118, live events associated with the particular location of the PMS computing device 118, and/or an organization associated with the PMS computing device 118.

Additionally or alternatively, based on the set of configuration parameters, one or more application instance access permissions associated with one or more respective application instance functionalities may be granted or restricted. For example, the PMS computing device 118 may determine, based on network status data, that the PMS computing device 118 is connected to an untrusted network and therefore needs to restrict one or more application instance access permissions. As such, the PMS computing device 118 may disable one or more application instance functionalities associated with the one or more respective application instance access permissions.

The one or more UUTs 120a-n may be a particular hardware component, software component, or a combination thereof associated with an enterprise-level production environment associated with the PMS 104 and the IDS 102. For example, a particular UUT 120a may be an aerospace gateway computing device configured as a line replaceable unit (LRU) constructed to be compatible with one or more aerial vehicles. As another example, a particular UUT 120a may be a discrete portion of executable program code (e.g., a software application under development by an enterprise associated with the PMS 104 and the IDS 102).

The PMS datastore 122 may include hardware, software, firmware, and/or a combination thereof capable of storing, recording, updating, retrieving and/or deleting computer-readable data and information related to the PMS 104 and/or the IDS 102. For example, the PMS datastore 122, in some contexts, stores testing operation data, testing result data, and/or visual indicia data. In some contexts, the PMS datastore 122 can be accessible via a communications network (e.g., the network 116) by one or more components of the various embodiments of the present disclosure. In various embodiments, the PMS datastore 122 may configured as a cloud-based storage system accessible via a communications network (e.g., the network 116) by one or more components of the various embodiments of the present disclosure.

In various embodiments, network 116 is any suitable network or combination of networks and supports any appropriate protocol suitable for communication of data to and from components of the PMS 104 and between various other components in the environment 100 (e.g., components of the IDS 102). According to various embodiments, network 116 includes a public network (e.g., the Internet), a private network (e.g., a network within an organization), or a combination of public and/or private networks. In one or more embodiments, the network 116 is implemented as a wireless network, a wired network (e.g., Ethernet), a local area network (LAN), a Wide Area Network (WAN), a Bluetooth network, a near field communication (NFC) network, or any other type of network that provides communications between one or more components of the network layout. In some embodiments, the network 116 is implemented using cellular networks, satellite, licensed radio, or a combination of cellular, satellite, licensed radio, and/or unlicensed radio networks.

In some embodiments the network 116 enables communication between various computing devices and/or systems utilizing one or more combinations of wireless and/or wired data transmission protocols. In this regard, the network 116 in some contexts embodies any of a myriad of network configurations. For example, in various contexts, the network 116 is configured to connect the PMS 104 to the IDS 102 during one or more predetermined network connectivity windows.

The network 116 in some embodiments includes one or more base stations, relays, routers, switches, cell towers, communications cables, satellites, radio antennas and/or related control systems, and/or associated routing stations, and/or the like. In some embodiments, the network 116 includes one or more user entity-controlled computing devices and/or other enterprise devices (e.g., an end-user's or enterprise router, modem, switch, and/or other network access point) and/or one or more external utility devices (e.g., Internet service provider communication towers, cell towers, and/or other devices).

FIG. 2 illustrates an example IDS computing device 106 in accordance with at least some example embodiments of the present disclosure. The IDS computing device 106, in some contexts, is a computing apparatus that may be deployed in many configurations. For example, the IDS computing device 106 may include, embody, and/or integrate with one or more computing devices, application servers, end user terminals, personal computers, mobile devices, user devices, and/or the like that are embodied in hardware, software, firmware, and/or a combination thereof.

The IDS computing device 106 may be configured to generate one or more interactive user interfaces for rendering on one or more electronic displays 212 associated. For example, in some embodiments, the IDS computing device 106 is configured to generate one or more interactive user dashboards 124 (e.g., a utilization dashboard and/or a production dashboard). The one or more interactive user dashboards 124 may comprise various interactive interface elements representing data related to the IDS 102, data related to one or more testing operations, data related to one or more testing results, data related to one or more visual indicia, and/or data related to the IDS datastore 112.

As depicted, the IDS computing device 106 includes a processing circuitry 202, memory 204, data storage circuitry 206, input/output circuitry 208, communication circuitry 210, electronic displays 212, and/or machine learning (ML) model circuitry 214. In some embodiments, the IDS computing device 106 is configured, using one or more of the sets of circuitry embodying processing circuitry 202, memory 204, input/output circuitry 208, communication circuitry 210, electronic displays 212, and/or ML model circuitry 214 to execute one or more operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processors, network interfaces, storage mediums, and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally or alternatively, in some embodiments, other elements of the IDS computing device 106 provide or supplement the functionality of another particular set of circuitry. For example, the processing circuitry 202 in some embodiments provides processing functionality to any of the other sets of circuitry, the memory 204 provides storage functionality to any of other the sets of circuitry, the communication circuitry 210 provides network interface functionality to any of the other sets of circuitry, and/or the like.

In some embodiments, the processing circuitry 202 (and/or co-processor or any other processing circuitry assisting or otherwise associated with the processor) is/are in communication with the memory 204 via a bus for passing information among components of the IDS computing device 106. In some embodiments, for example, the memory 204 is non-transitory and includes for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, and/or the like for enabling the IDS computing device 106 to carry out various functions in accordance with example embodiments of the present disclosure.

In various embodiments, the processing circuitry 202 is embodied in a number of different ways. For example, in some example embodiments, the processing circuitry 202 includes one or more processing devices configured to perform independently. Additionally or alternatively, in some embodiments, the processing circuitry 202 includes one or more processors configured in tandem via a bus to enable independent execution of instructions, pipelining, and/or multithreading. The use of the terms “processor” and “processing circuitry” should be understood to include a single core processor, a multi-core processor, and/or multiple processors internal to the IDS computing device 106, and/or one or more remote or “cloud” processors external to the IDS computing device 106.

In an example embodiment, the processing circuitry 202 is configured to execute instructions stored in the memory 204 or otherwise accessible to the processing circuitry 202. Additionally or alternatively, the processing circuitry 202 in some embodiments is configured to execute hard-coded functionality. As such, whether configured by hardware or software methods, or by a combination thereof, the processing circuitry 202 represents an entity (e.g., physically embodied in circuitry) capable of performing operations according to an embodiment of the present disclosure while configured accordingly. Additionally or alternatively, as another example in some example embodiments, when the processing circuitry 202 is embodied as an executor of software instructions, the instructions specifically configure the processing circuitry 202 to perform the algorithms embodied in the specific operations described herein when such instructions are executed.

In some embodiments, the processing circuitry 202 includes hardware, software, firmware, and/or a combination thereof, that generates, receives, and/or processes data including one or more portions of testing operation data (e.g., product, machine, environment, and/or testing operation data), testing data input confirmations, testing operation commands and/or instructions, visual indicia data (e.g., QR code data), ML model data, and/or the like. In various contexts, the processing circuitry 202 is configured to perform various operations associated with executing one or more testing operations associated with one or more UUTs 120a-n. Additionally or alternatively, in some embodiments, the processing circuitry 202 includes hardware, software, firmware, and/or a combination thereof, that causes rendering of one or more interactive user dashboards 124 and/or user interfaces, visual indicia, testing result data (e.g., KPC and/or SPC data), and/or the like.

Additionally, the processing circuitry 202 includes hardware, software, firmware, and/or a combination thereof, that is configured to encrypt and/or or decrypt the one or more portions of testing operation data (e.g., product, machine, environment, and/or testing operation data), testing data input confirmations, testing operation commands and/or instructions, visual indicia data (e.g., QR code data), ML model data, and/or the like. For example, the processing circuitry 202 may be configured to generate one or more encryption key pairs (e.g., public/private key pairs) for one or more portions of data related to a testing data input summary and/or one or more portions of testing result data such that only an authorized computing device (e.g., an authorized PMS computing device 118) is able to decrypt, read, and/or access the encrypted testing input summary data and/or the encrypted testing result data.

In some embodiments, IDS computing device 106 includes data storage circuitry 206 that is configured to store, update, retrieve, delete, and/or otherwise manage one or more portions of data associated with the IDS 102. In some embodiments, for example, the data storage circuitry 206 is non-transitory and includes for example, one or more volatile and/or non-volatile memories. In other words, for example, the data storage circuitry 206 in some embodiments includes or embodies an electronic storage device (e.g., a computer readable storage medium). In some embodiments, the data storage circuitry 206 is configured to store information, data, content, applications, instructions, or the like, for enabling the IDS computing device 106 to carry out various functions in accordance with example embodiments of the present disclosure.

In various embodiments, the data storage circuitry 206 embodies, or integrates with, one or more datastores (e.g., the IDS datastore 112), a server system, a collection of databases, and/or any other type of non-transitory storage medium. Additionally, in some embodiments, the data storage circuitry 206 is configured to store, update, retrieve, delete, and/or otherwise maintain any training data associated with any models associated with the ML model circuitry 214 (e.g., the IDS classification model 110).

In some embodiments, the IDS computing device 106 includes input/output circuitry 208 that provides output to the user and, in some embodiments, to receive an indication of a user input. In some embodiments, the input/output circuitry 208 is in communication with the processing circuitry 202 to provide such functionality. The input/output circuitry 208 in some contexts comprises one or more user interfaces and, in some embodiments, includes a display that comprises the interfaces rendered as an application user interface, a user device, a diagnostic and/or testing system, or the like. In some embodiments, the input/output circuitry 208 also includes a keyboard, a mouse, a joystick, a touch screen, touch areas, soft keys a microphone, a speaker, or other input/output mechanisms. Additionally or alternatively, in some embodiments, the input/output circuitry 208 embodies or integrates with an IDS scanning device 108.

The processing circuitry 202, and/or input/output circuitry 208 comprising a processor, in some embodiments is configured to control one or more functions of one or more user interface elements through computer program instructions (e.g., software and/or firmware) stored on a memory accessible to the processing circuitry 202 (e.g., memory 204, and/or the like). In some embodiments, the input/output circuitry 208 includes or utilizes a user-facing application to provide input/output functionality to a computing device and/or other display associated with a user. Additionally or alternatively, in some embodiments, the input/output circuitry 208 includes one or more software-rendered user interfaces including interface elements that depict particular data and/or information, and/or that receive user input. Additionally or alternatively, in some embodiments, the input/output circuitry 208 embodies, integrates with, and/or is otherwise associated with one or more electronic displays 212.

The communication circuitry 210 includes any means such as a device or circuitry embodied in either hardware or a combination of hardware and software that is configured to receive and/or transmit data from/to a communications network and/or any other computing device, circuitry, or module in communication with the IDS computing device 106. In this regard, the communication circuitry 210 includes, for example in some embodiments, a network interface for enabling communications with a wired or wireless communications network. Additionally or alternatively in some embodiments, the communication circuitry 210 includes one or more network interface cards, antennas, buses, switches, routers, modems, and supporting hardware, firmware, and/or software, or any other device suitable for enabling communications via one or more communications networks. Additionally or alternatively, the communication circuitry 210 includes circuitry for interacting with the antennas and/or other hardware or software to cause transmission of signals via the antennas or to handle receipt of signals received via the antennas.

The electronic displays 212 associated with the IDS computing device 106 may comprise, in various contexts, one or more computer displays, terminal displays, touchscreen displays, LED displays, LCD displays, and/or the like. The electronic displays 212 are configured to display one or more portions of data related to one or more interactive user dashboards 124 (e.g., utilization dashboard and/or production dashboards), user interfaces, testing operation data, testing result data, visual indicia data (e.g., QR code data), and/or the like.

The ML model circuitry 214 includes hardware, software, firmware, and/or a combination thereof, that supports functionality associated with the one or more ML models associated with the IDS 102. In various embodiments, the ML model circuitry 214 comprises one or more statistical, algorithmic, and/or ML models associated with the IDS 102. In some contexts, the ML model circuitry 214 comprises one or more math models, rule expression models and/or specialized deep learning neural networks. In one or more embodiments, the ML model circuitry 214 is configured to employ, direct, and/or otherwise manage an IDS classification model 110 associated with the IDS 102.

For example, the ML model circuitry 214 may be configured to execute, at least in part, one or more portions of program code associated with the methods and operations of the IDS classification model 110. In such examples, the ML model circuitry 214 may include hardware, software, firmware, and/or a combination thereof, that receives and/or analyzes one or more portions of model input comprising one or more portions of testing result data associated with one or more UUTs 120a-n.

Additionally, in various embodiments, the ML model circuitry 214 includes hardware, software, firmware, and/or a combination thereof, that in some contexts is employed to train and/or retrain the IDS classification model 110 based at least in part on one or more portions of prior testing operating data, prior testing result data, and/or one or more portions of data related to the IDS 102 and/or PMS 104. In various embodiments, the ML model circuitry 214 is configured to facilitate the training and/or retraining of the IDS classification model 110 based at least in part on a predefined schedule such as, for example, daily, weekly, bi-weekly, monthly, and/or the like. In this regard, the ML model circuitry 214 includes hardware, software, firmware, and/or a combination thereof, that causes the storage, updating, retrieval, and/or the deletion of one or more portions of data associated with the IDS classification model 110.

It will be appreciated that, further in some embodiments, two or more of the sets of circuitries 202-214 are combinable. Additionally or alternatively, in some embodiments, one or more of the sets of circuitry 202-214 perform some or all of the functionality described associated with another component. For example, in some embodiments, one or more of the sets of circuitry 202-214 are combined into a single component embodied in hardware, software, firmware, and/or a combination thereof.

FIG. 3 illustrates an example PMS computing device 118 in accordance with at least some example embodiments of the present disclosure. The PMS computing device 118, in some contexts, is a computing apparatus that may be deployed in many configurations. For example, the PMS computing device 118 may include, embody, and/or integrate with one or more computing devices, personal computers, mobile devices, user devices, smartphones, tablet computers, laptops, application servers, end user terminals, and/or the like that are embodied in hardware, software, firmware, and/or a combination thereof.

The PMS computing device 118 may be configured to generate one or more interactive user interfaces for rendering on one or more electronic displays 312 associated. For example, in some embodiments, the PMS computing device 118 is configured to generate one or more user dashboards and/or user interfaces (e.g., user interfaces associated with a PMS application instance 126). The one or more user dashboards may comprise various interactive interface elements representing data related to the PMS 104, data related to the IDS 102, data related to one or more testing operations, data related to one or more testing results, data related to one or more visual indicia, and/or data related to the PMS datastore 122.

As depicted, the PMS computing device 118 includes a processing circuitry 302, memory 304, data storage circuitry 306, input/output circuitry 308, communication circuitry 310, electronic displays 312, cameras 314, and/or a global positioning system (GPS) device 316. In some embodiments, the PMS computing device 118 is configured, using one or more of the sets of circuitry embodying processing circuitry 302, memory 304, input/output circuitry 308, communication circuitry 310, electronic displays 312, cameras 314, and/or GPS device 316 to execute one or more operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processors, network interfaces, storage mediums, and/or the like, to perform their associated functions, such that duplicate hardware is not required for each set of circuitry.

In some embodiments, the processing circuitry 302 (and/or co-processor or any other processing circuitry assisting or otherwise associated with the processor) is/are in communication with the memory 304 via a bus for passing information among components of the PMS computing device 118. In some embodiments, for example, the memory 304 is non-transitory and includes for example, one or more volatile and/or non-volatile memories. In other words, for example, the memory 304 in some embodiments includes or embodies an electronic storage device (e.g., a computer readable storage medium). In some embodiments, the memory 304 is configured to store information, data, content, applications, instructions, and/or the like for enabling the PMS computing device 118 to carry out various functions in accordance with example embodiments of the present disclosure.

In various embodiments, the processing circuitry 302 is embodied in a number of different ways. For example, in some example embodiments, the processing circuitry 302 includes one or more processing devices configured to perform independently. Additionally or alternatively, in some embodiments, the processing circuitry 302 includes one or more processors configured in tandem via a bus to enable independent execution of instructions, pipelining, and/or multithreading. The use of the terms “processor” and “processing circuitry” should be understood to include a single core processor, a multi-core processor, and/or multiple processors internal to the PMS computing device 118, and/or one or more remote or “cloud” processors external to the PMS computing device 118.

In an example embodiment, the processing circuitry 302 is configured to execute instructions stored in the memory 304 or otherwise accessible to the processing circuitry 302. Additionally or alternatively, the processing circuitry 302 in some embodiments is configured to execute hard-coded functionality. As such, whether configured by hardware or software methods, or by a combination thereof, the processing circuitry 302 represents an entity (e.g., physically embodied in circuitry) capable of performing operations according to an embodiment of the present disclosure while configured accordingly. Additionally or alternatively, as another example in some example embodiments, when the processing circuitry 302 is embodied as an executor of software instructions, the instructions specifically configure the processing circuitry 302 to perform the algorithms embodied in the specific operations described herein when such instructions are executed.

In some embodiments, the processing circuitry 302 includes hardware, software, firmware, and/or a combination thereof, that generates, receives, and/or processes data including one or more portions of testing operation data (e.g., product, machine, environment, and/or testing operation data), testing data input confirmations, testing operation commands and/or instructions, visual indicia data (e.g., QR code data), ML model data, and/or the like. In various contexts, the processing circuitry 302 is configured to perform various operations associated with executing one or more testing operations associated with one or more UUTs 120a-n. Additionally or alternatively, in some embodiments, the processing circuitry 302 includes hardware, software, firmware, and/or a combination thereof, that causes rendering of one or more user dashboards and/or user interfaces, application instances, visual indicia, testing result data (e.g., KPC and/or SPC data), and/or the like.

In some embodiments, PMS computing device 118 includes data storage circuitry 306 that is configured to store, update, retrieve, delete, and/or otherwise manage one or more portions of data associated with the PMS 104. In some embodiments, for example, the data storage circuitry 306 is non-transitory and includes for example, one or more volatile and/or non-volatile memories. In other words, for example, the data storage circuitry 306 in some embodiments includes or embodies an electronic storage device (e.g., a computer readable storage medium). In some embodiments, the data storage circuitry 306 is configured to store information, data, content, applications, instructions, or the like, for enabling the PMS computing device 118 to carry out various functions in accordance with example embodiments of the present disclosure. Additionally, in various embodiments, the data storage circuitry 306 embodies, or integrates with, one or more datastores (e.g., the PMS datastore 122), a server system, a collection of databases, and/or any other type of non-transitory storage medium.

In some embodiments, the PMS computing device 118 includes input/output circuitry 308 that provides output to the user and, in some embodiments, to receive an indication of a user input. In some embodiments, the input/output circuitry 308 is in communication with the processing circuitry 302 to provide such functionality. The input/output circuitry 308 in some contexts comprises one or more user interfaces and, in some embodiments, includes a display that comprises the interfaces rendered as an application user interface, a user device, a diagnostic and/or testing system, or the like. In some embodiments, the input/output circuitry 308 also includes a keyboard, a mouse, a joystick, a touch screen, touch areas, soft keys a microphone, a speaker, or other input/output mechanisms.

The processing circuitry 302, and/or input/output circuitry 308 comprising a processor, in some embodiments is configured to control one or more functions of one or more user interface elements through computer program instructions (e.g., software and/or firmware) stored on a memory accessible to the processing circuitry 302 (e.g., memory 304, and/or the like). In some embodiments, the input/output circuitry 308 includes or utilizes a user-facing application to provide input/output functionality to a computing device and/or other display associated with a user. Additionally or alternatively, in some embodiments, the input/output circuitry 308 includes one or more software-rendered user interfaces including interface elements that depict particular data and/or information, and/or that receive user input. Additionally or alternatively, in some embodiments, the input/output circuitry 308 embodies, integrates with, and/or is otherwise associated with one or more electronic displays 312.

The communication circuitry 310 includes any means such as a device or circuitry embodied in either hardware or a combination of hardware and software that is configured to receive and/or transmit data from/to a communications network and/or any other computing device, circuitry, or module in communication with the PMS computing device 118. In this regard, the communication circuitry 310 includes, for example in some embodiments, a network interface for enabling communications with a wired or wireless communications network. Additionally or alternatively in some embodiments, the communication circuitry 310 includes one or more network interface cards, antennas, buses, switches, routers, modems, and supporting hardware, firmware, and/or software, or any other device suitable for enabling communications via one or more communications networks. Additionally or alternatively, the communication circuitry 310 includes circuitry for interacting with the antennas and/or other hardware or software to cause transmission of signals via the antennas or to handle receipt of signals received via the antennas.

The electronic displays 312 associated with the PMS computing device 118 may comprise, in various contexts, one or more computer displays, terminal displays, touchscreen displays, LED displays, LCD displays, and/or the like. The electronic displays 312 are configured to display one or more portions of data related to one or more user dashboards, user interfaces, testing operation data, testing result data, visual indicia data (e.g., QR code data), and/or the like.

The cameras 314 associated with the PMS computing device 118 may be configured to facilitate one or more operations and/or interactions associated with the PMS 104 and the IDS 102. For example, the cameras 314 may be employed to scan and/or decode visual indicia rendered on an electronic display associated with the IDS 102 (e.g., the electronic display 212 of the IDS computing device 106). Additionally, in some examples, the camera 314 may be employed to facilitate a user authentication associated with a PMS application instance 126 associated with the PMS 104 and/or a user authentication associated with the PMS computing device 118 itself.

The GPS device 316 associated with the PMS computing device 118 may be configured to determine a current location of the PMS computing device 118 within the real-world environment. As described herein, one or more portions of location data related to the PMS computing device 118 may be employed to determine one or more configuration parameters associated with a PMS application instance 126 associated with the PMS computing device 118. For example, the one or more portions of location data may be employed to determine a respective user interface display theme associated with the PMS application instance 126.

It will be appreciated that, further in some embodiments, two or more of the sets of circuitries 302-316 are combinable. Additionally or alternatively, in some embodiments, one or more of the sets of circuitry 302-316 perform some or all of the functionality described associated with another component. For example, in some embodiments, one or more of the sets of circuitry 302-316 are combined into a single component embodied in hardware, software, firmware, and/or a combination thereof.

### Example Data Flows of the Disclosure

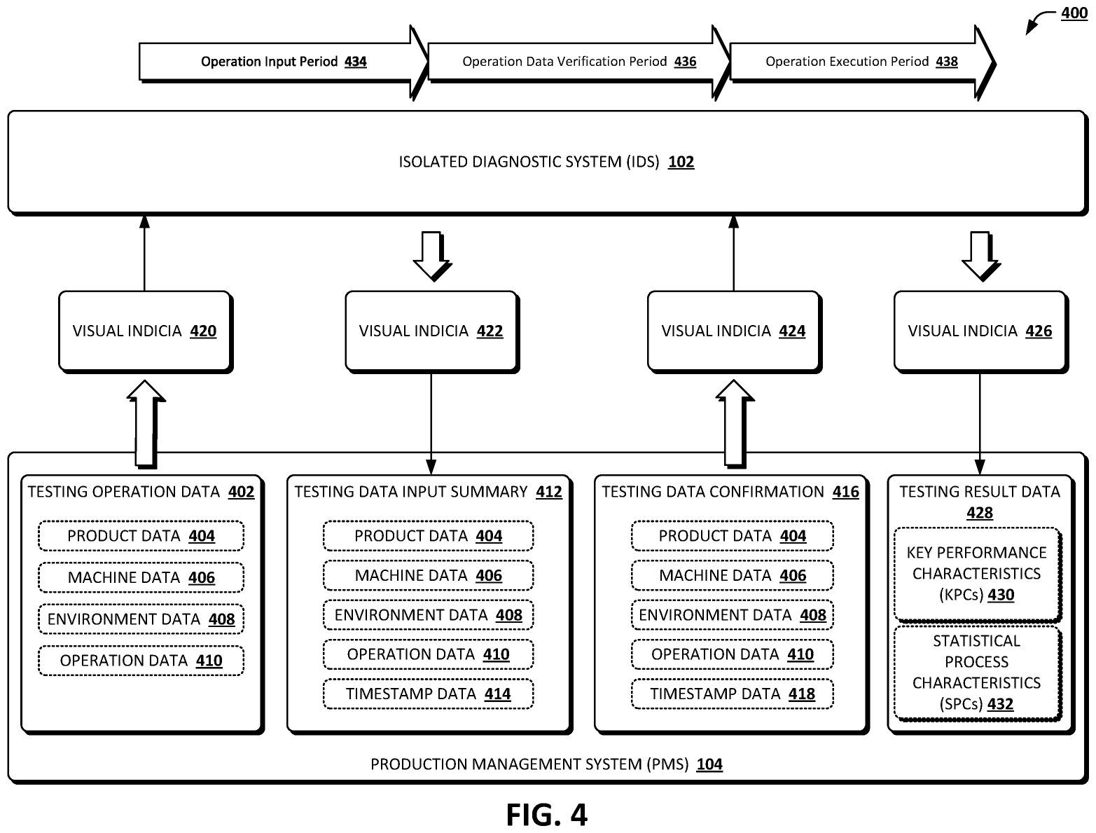

FIG. 4 illustrates an example data flow related to a testing operation associated with a unit under test (UUT) 120a facilitated by an IDS 102 and a PMS 104 in accordance with at least some example embodiments of the present disclosure. Specifically, FIG. 4 shows an example sequence related to the generation, transmission, and reception of data related to the execution of testing operation. In various embodiments, the configuration, verification, and execution of one or more respective testing operations may happen over the course of an operation input period 434, an operation data verification period 436, and/or an operation execution period 438. Based at least in part on the sequence of the operation input period 434, the operation data verification period 436, and/or the operation execution period 438, one or more components of the PMS 104 and the IDS 102 may guide the configuration, verification, and/or execution of one or more respective testing operations related to a particular UUT 120a.

For example, during a respective operation input period 434, a PMS computing device 118 associated with the PMS 104 may be configured to generate testing operation data 402. The testing operation data 402 may comprise one or more portions of testing and/or diagnostic configuration data associated with a particular UUT 120a. In various examples, testing operation data 402 may be generated, compiled, organized, structured, parsed, stored, and/or otherwise managed by a PMS 104. A PMS computing device 118 associated with the PMS 104 may be configured to generate one or more visual indicia 420 (e.g., one or more QR codes) associated with various portions of testing operation data 402. In certain examples, the one or more visual indicia 420 may be rendered via a PMS application instance 126 on the PMS computing device 118.

In some embodiments, testing operation data 402 may comprise product data 404, machine data 406, environment data 408, and/or operation data 410 related to a particular UUT 120a and/or a testing operation related to the particular UUT 120a. Product data 404 associated with a UUT 120a may comprise at least one or more of identification data, manufacture data, location data, material composition data, computer program code library data (e.g., programing language data), software data, intended use data, historical usage data, and/or the like. Machine data 406 associated with a UUT 120a may comprise at least one or more of hardware component data, technical specification data, hardware connection data, processor data, memory data, datastore data, networking connectivity data, and/or the like.

In various embodiments, a PMS computing device 118 may be configured to obtain the product data 404 and/or the machine data 406 associated with a particular UUT 120a by scanning one or more visual indicia associated with the UUT 120a. For example, one or more visual indicia comprising the product data 404 and/or the machine data 406 may be adhered to, coupled to, and/or otherwise associated with the UUT 120a such that the PMS computing device 118 is able to scan and/or decode the one or more visual indicia to obtain the respective product data 404 and/or machine data 406.

Environment data 408 may be associated with one or more testing environments and/or constraints associated with one or more testing operations to be executed with regards to a particular UUT 120a. In various examples, environment data 408 may comprise at least one or more of operational constraint data, operational condition data, operational circumstance data, operational medium data (e.g., physical mediums), operational location data, operational limitation data, environmental factor data, simulation operational, preference and/or setting configuration data, and/or the like. In various examples, environment data 408 may be representative of a current real-world environment associated with the UUT 120a. Alternatively, in various other examples, environment data 408 may be representative of a simulated environment for which the UUT 120a may be employed in and/or exposed to in a future scenario (e.g., upon completion of the development of the UUT 120a).

Operation data 410 may be associated with one or more commands, instructions, configurations, sequences, and/or procedures associated with one or more testing operations to be executed with regards to a particular UUT 120a. In various examples, the one or more testing operations may be related to one or more respective tests, experiments, measurements, predictions, modellings, observations, and/or analyses to be executed with regards to a particular UUT 120a. The operation data 410 may be employed to direct, instruct, and/or otherwise configure an IDS computing device 106 to execute the one or more testing operations based on one or more of product data 404, machine data 406, and/or environment data 408 related to a particular UUT 120a.

In various embodiments, a PMS computing device 118 may be configured to obtain the environment data 408 and/or the operation data 410 associated with a particular testing operation by scanning one or more visual indicia associated with the testing operation. For example, one or more visual indicia comprising the environment data 408 and/or the operation data 410 may be accessible such that the PMS computing device 118 is able to scan and/or decode the one or more visual indicia to obtain the respective environment data 408 and/or operation data 410.

Once the PMS computing device 118 generates the one or more visual indicia 420 associated with the testing operation data 402 (e.g., during the operation input period 434), the PMS computing device 118 may render the visual indicia 420 (e.g., via the PMS application instance 126). The visual indicia 420 may be scanned and/or decoded by an IDS scanning device 108 such that an IDS computing device 106 may receive and subsequently process the testing operation data 402.

Upon processing the testing operation data 402, the IDS computing device 106 may generate a testing data input summary 412 as a first step of the operation data verification period 436. In this regard the IDS 102 can confirm the intended testing operations to be performed with regard to the respective UUT 120a. In various examples, the testing data input summary 412 comprises the product data 404, the machine data 406, the environment data 408, and/or the operation data 410. The IDS computing device 106 may generate and/or encode the testing data input summary 412 as one or more visual indicia 422 and render the one or more visual indicia 422 on an electronic display 212. Additionally, the IDS computing device 106 may be configured to encode the testing data input summary 412 with timestamp data 414.

The PMS computing device 118 can scan and/or decode the visual indicia 422 (e.g., via the cameras 314) in order to obtain and process the data comprised in the testing data input summary 412. The PMS computing device 118 can confirm the validity of the testing data input summary 412 and therefore confirm that the IDS 102 has the data necessary to correctly execute the one or more testing operations associated with the respective UUT 120a. Furthermore, the PMS computing device 118 can confirm, based on the timestamp data 414, the freshness of the testing data input summary 412 and, respectively, the freshness of the testing operation data 402. In some examples, the freshness of the testing operation data 402 and/or the testing data input summary 412 describes whether the testing operation data 402 and/or the testing data input summary 412 have been generated and/or verified within a corresponding operation input period 434 or operation data verification period 436 respectively. For example, in various embodiments, the IDS 102 is configured to set an expiration timeframe associated with the operation data verification period 436. If the expiration timeframe is surpassed before the PMS computing device 118 verifies the testing data input summary 412 (e.g., scans and/or decodes the corresponding visual indicia 422), the IDS 102 may be configured to terminate the current testing operation associated with the respective UUT 120a.

However, if the PMS computing device 118 verifies the freshness and validity of the testing data input summary 412, the PMS computing device 118 may be configured to generate a testing data confirmation 416 comprising the product data 404, the machine data 406, the environment data 408, and/or the operation data 410. Additionally, the PMS computing device 118 may be configured to encode the testing data confirmation 416 with timestamp data 418 upon verifying the validity and/or freshness of the testing data input summary 412. The PMS computing device 118 is also configured to generate one or more visual indicia 424 associated with the testing data confirmation 416 and render the one or more visual indicia 424 on the electronic displays 312.

The IDS scanning device 108 may be configured to scan and/or decode the one or more visual indicia 424 rendered on the electronic display 312 of the PMS computing device 118. If the IDS computing device 106 confirms the testing data confirmation 416 before the end of the expiration timeframe associated with the operation data verification period 436, the IDS computing device 106 will proceed to execute the one or more testing operations associated with the respective UUT 120a. As such, the testing data confirmation 416, and therefore the corresponding visual indicia 424, are configured to initiate and/or cause execution of the one or more testing operations by the IDS 102.

The one or more testing operations associated with the respective UUT 120a are executed by the IDS computing device 106 during the operation execution period 438. After completion of the one or more testing operations, the IDS computing device 106 may be configured to generate one or more portions of testing result data 428. Furthermore, as described herein, the IDS classification model 110 may be configured to classify one or more portions of the testing result data 428 as KPCs 430. The KPCs 430 are portions of testing result data 428 that are deemed to be the most relevant, pertinent, important, and/or critical with regards to the performance of the respective UUT 120a based on one or more testing operations. For example, in various contexts, one or more KPCs 430 may be associated with “out-of-family” data generated during the testing operations, where the out-of-family data may represent statistical outliers, anomalies, and/or unexpected behavior. In this regard, KPCs 430 may represent both favorable and unfavorable outcomes related to one or more testing operations associated with a particular UUT 120a and are therefore considered critical pieces of testing result data 428.

Additionally or alternatively, the IDS classification model 110 may be configured to classify one or more portions of the testing result data 428 as SPCs 432. The SPCs 432 are portions of testing result data 428 that are portions of data related to the process associated with the execution of the one or more testing operations that are generated or gathered during the execution of one or more testing operations. SPCs 432 may be samples of data extracted during the execution of the one or more testing operations that indicate variations in the quality of the testing being executed with regard to a particular UUT 120a, variations in performance of the UUT 120a during the one or more testing operations, and/or variations in the output of the testing result data 428. Based on one or more SPCs, it may be determined that at least one of a configuration of the UUT 120a, a configuration of the testing operation data 402, and/or a configuration of the IDS 102 needs to be updated, revised, and/or reconfigured to ensure the quality control of the UUT 120a, the testing operations, and/or the IDS 102.

In various embodiments, the IDS computing device 106 is configured to generate one or more visual indicia 426 associated with one or more KPCs 430 and/or one or more SPCs 432 and render the one or more visual indicia 426 on the electronic displays 212 of the IDS computing device 106. In this regard, the PMS computing device 118 can scan and/or decode the visual indicia 426 in order to obtain and/or process the KPCs 430 and/or the SPCs 432 associated with the testing result data 428 generated during the one or more testing operations associated with a respective UUT 120a.

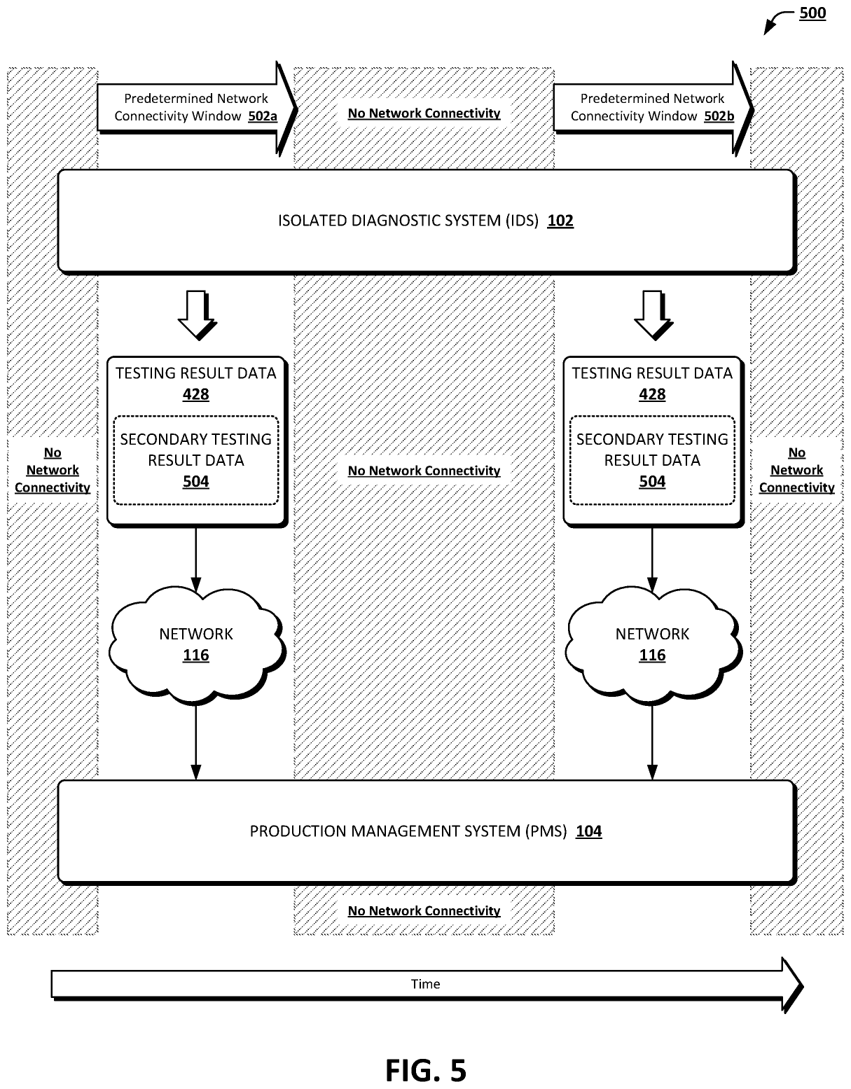

FIG. 5 illustrates an example data flow related to the transmission of testing result data 428 from an IDS 102 to a PMS 104 in accordance with at least some example embodiments of the present disclosure. Specifically, FIG. 5 illustrates the transmission of secondary testing result data 504 during respective predetermined network connectivity windows 502a-n. In various embodiments, an IDS 102 remains isolated from outside network connectivity while executing one or more testing operations associated with a particular UUT 120a. The IDS 102 also remains isolated from outside network connectivity while the IDS 102 is transferring primary testing result data 428 to the PMS 104 (e.g., via one or more visual indicia 426 associated with one or more KPCs 430 and/or one or more SPCs 432).

However, in various examples, the IDS 102 may be configured to connect to the PMS 104 via a common network (e.g., the network 116) during one or more predetermined network connectivity windows 502a-n. The one or more predetermined network connectivity windows 502a-n are associated with a temporary network connection between the IDS 102 and the PMS 104. By employing the predetermined network connectivity windows 502a-n, an IDS 102 can remain secure against outside cyberthreats by ensuring that the IDS 102 only transmits data (e.g., secondary testing result data 504) to a PMS 104 via a common network (e.g., the network 116) during a short, pre-scheduled amount of time. In various examples, a predetermined network connectivity window 502a may be associated with a predefined transmission duration (e.g., a transmission duration of one minute). Furthermore, a predetermined network connectivity window 502a may be associated with a network connectivity schedule. For example, a predetermined network connectivity window 502a may have a predefined transmission duration of one minute and may be scheduled to occur only once during a twenty-four-hour period.

As such, the IDS 102 may be configured to transfer secondary testing result data 504 to the PMS 104 during the one or more predetermined network connectivity windows 502a-n. In various examples, the secondary testing result data 504 is data that has been classified by the IDS classification model 110 as being of secondary importance, secondary criticality, and/or the like. For example, the secondary testing result data 504 may be any testing result data 428 that has not been classified as a KPC 430 and/or an SPC 432. In various examples, the secondary testing result data 504 represents the majority of the testing result data 428 and, as such, may be too exhaustive and/or may be associated with a data size that prohibits the secondary testing result data 504 from being communicated via one or more visual indicia (e.g., visual indicia 426).

In various embodiments, the IDS 102 is configured to determine at least one or more of a transmission progress, a transmission success, or a transmission failure associated with one or more portions of secondary testing result data 504 transmitted to the PMS 104 during the one or more predetermined network connectivity windows 502a-n. Additionally, the IDS 102 may be configured to encrypt the secondary testing result data 504 such that only intended computing devices (e.g., the PMS computing device 118) are able to decrypt, receive, access, and/or process the secondary testing result data 504. As such, an authorized PMS computing device 118 may be configured to decrypt and/or cause storage of the secondary testing result data 504. For example, the PMS computing device 118 may be configured to cause storage of the secondary testing result data 504 in the PMS datastore 122.

### Example Processes of the Disclosure

Having described example systems, apparatuses, data flows, user interfaces, and user interface elements in accordance with the present disclosure, example processes of the disclosure will now be discussed. It will be appreciated that each of the flowcharts depicts an example computer-implemented process that is performable by various means, including one or more of the apparatuses, systems, devices, and/or computer program products described herein, for example utilizing one or more of the specially configured components thereof.

It will be understood that each block of the processes, and combinations of blocks in the flowcharts, may be implemented by various means including hardware and/or a computer program product comprising one or more computer-readable mediums having computer-readable program instructions stored thereon. For example, one or more of the processes described herein in some embodiments is/are embodied by computer program of a computer program product. In this regard, the computer program products that embody the processes described herein in some embodiments comprise one or more non-transitory memory devices of a computing device, apparatus, and/or the like.

In some embodiments, the computer program instructions of the computer program product that embody the processes are stored by non-transitory computer-readable storage mediums of a plurality of computing devices. It will be appreciated that any such computer program products may be loaded onto one or more computers and/or other programmable apparatuses such that the computer program product including the program code instructions that execute on the computers or other programmable apparatuses create means for implementing the functions specified in the operational blocks.

Further, in some embodiments, the computer program product includes one or more non-transitory computer-readable memories on which the computer program instructions are stored such that the one or more computer-readable memories can direct one or more computers and/or other programmable apparatuses to function in a particular manner, such that the computer program product comprises an article of manufacture that implements the functions specified in the operational blocks. Additionally or alternatively, in some embodiments, the computer program instructions of one or more computer program products are loaded onto computing devices or other programmable apparatuses to cause a series of operations to be performed on the computing devices or other programmable apparatuses a computer-implemented process such that the instructions that execute on the computing devices or other programmable apparatuses implement the functions specified in the operational blocks.

Each of the processes depicted includes a plurality of operational blocks defining a particular algorithm for performing one or more portions of functionality for executing one or more testing operations associated with one or more UUTs 120a-n, generating and/or outputting improved user interfaces and/or user dashboards on one or more electronic displays (e.g., electronic displays 212 and/or 312), and/or applying various user interface displays and user access permissions to a PMS application instance of a PMS computing device 118 as described herein. The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process.

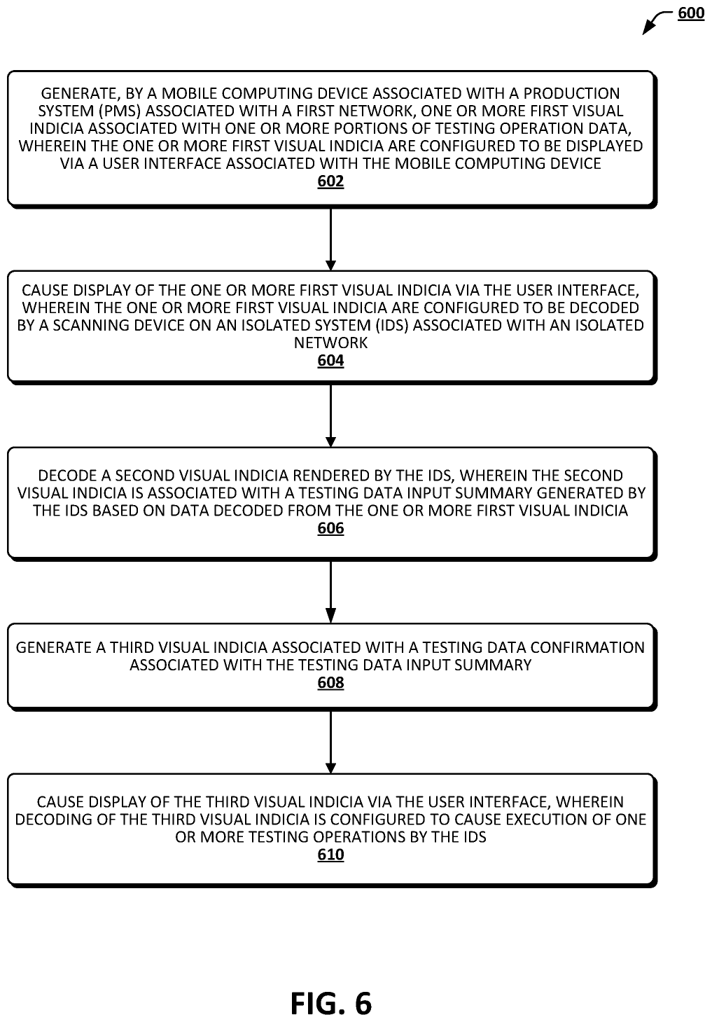

FIG. 6 illustrates a flowchart depicting example operations of an example process 600 for executing a testing operation associated with a UUT facilitated by an IDS and a PMS in accordance with at least some example embodiments of the present disclosure. In some embodiments, the process 600 is embodied by a computer-implemented process executable by any of a myriad of computing devices, apparatuses, systems, and/or the like as described herein. Additionally or alternatively, in some embodiments, the process 600 is embodied by computer program code stored on a non-transitory computer-readable storage medium of a computer program product configured for execution to perform the process as depicted and described.

Additionally or alternatively, in some embodiments, the process 600 is performed by one or more specially configured computing devices, such as the PMS computing device 118 alone or in communication with one or more other components, devices, systems, and/or the like (e.g., the IDS computing device 106). In this regard, in some such embodiments, the PMS computing device 118 is specially configured by computer-coded instructions (e.g., computer program instructions) stored thereon, for example in the memory 304 and/or another component depicted and/or described herein and/or otherwise accessible to the PMS computing device 118, for performing the operations as depicted and described. In some embodiments, the PMS computing device 118 is in communication with one or more external apparatuses, systems, devices, and/or the like, to perform one or more of the operations as depicted and described. For example, the PMS computing device 118 in some embodiments is in communication with an end-user computing device, one or more external systems, and/or the like. It will be appreciated that while the process 600 is described as performed by and from the perspective of the PMS computing device 118 for purposes of simplifying the description, the process 600 can also be performed, in total or in part, by the IDS computing device 106.

The process 600 begins at operation 602. At operation 602, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that generates, by a mobile computing device associated with a PMS 104 associated with a first network (e.g., network 116), one or more first visual indicia (e.g., visual indicia 420) associated with one or more portions of testing operation data 402, where the one or more first visual indicia are configured to be displayed via a user interface (e.g., PMS application instance 126) associated with the mobile computing device.

At operation 604, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that causes display of the one or more first visual indicia (e.g., the visual indicia 420) via the user interface (e.g., the PMS application instance 126), where the one or more first visual indicia are configured to be decoded by a scanning device (e.g., IDS scanning device 108) in an IDS 102 associated with an isolated network (e.g., isolated network 114).

At operation 606, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that decodes a second visual indicia (e.g., visual indicia 422) rendered by the IDS 102 (e.g., via the IDS computing device 106), where the second visual indicia is associated with a testing data input summary 412 generated by the IDS 102 based on data decoded from the one or more first visual indicia.

At operation 608, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that generates a third visual indicia (e.g., visual indicia 424) associated with a testing data confirmation 416 associated with the testing data input summary 412.

At operation 610, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that causes display of the third visual indicia (e.g., the visual indicia 424) via the user interface (e.g., the PMS application instance 126), where decoding of the third visual indicia (e.g., by the IDS computing device 106) is configured to cause execution of one or more testing operations by the IDS 102.

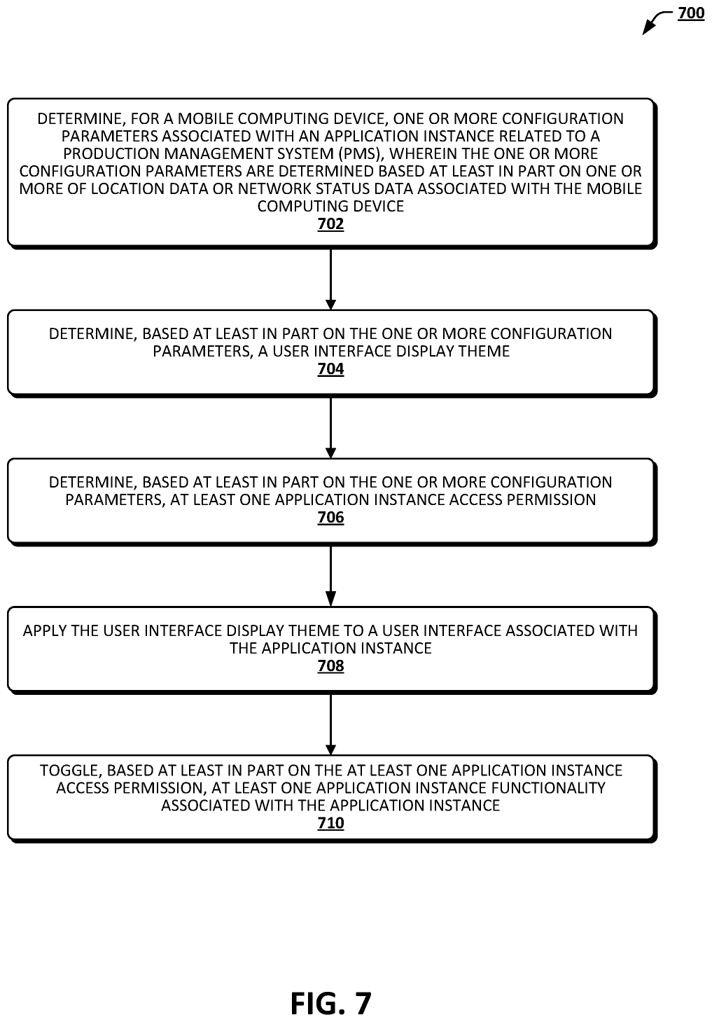

FIG. 7 illustrates a flowchart depicting example operations of an example process 700 for configuring a PMS application instance associated with a PMS in accordance with at least some example embodiments of the present disclosure. In some embodiments, the process 700 is embodied by a computer-implemented process executable by any of a myriad of computing devices, apparatuses, systems, and/or the like as described herein. Additionally or alternatively, in some embodiments, the process 700 is embodied by computer program code stored on a non-transitory computer-readable storage medium of a computer program product configured for execution to perform the process as depicted and described.

Additionally or alternatively, in some embodiments, the process 700 is performed by one or more specially configured computing devices, such as the PMS computing device 118 alone or in communication with one or more other components, devices, systems, and/or the like (e.g., the IDS computing device 106). In this regard, in some such embodiments, the PMS computing device 118 is specially configured by computer-coded instructions (e.g., computer program instructions) stored thereon, for example in the memory 304 and/or another component depicted and/or described herein and/or otherwise accessible to the PMS computing device 118, for performing the operations as depicted and described. In some embodiments, the PMS computing device 118 is in communication with one or more external apparatuses, systems, devices, and/or the like, to perform one or more of the operations as depicted and described. For example, the PMS computing device 118 in some embodiments is in communication with an end-user computing device, one or more external systems, and/or the like. It will be appreciated that while the process 700 is described as performed by and from the perspective of the PMS computing device 118 for purposes of simplifying the description, the process 700 can also be performed, in total or in part, by the IDS computing device 106.

The process 700 begins at operation 702. At operation 702, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that determines, for a mobile computing device (e.g., PMS computing device 118), one or more configuration parameters associated with an application instance (e.g., PMS application instance 126) related to a PMS 104, where the one or more configuration parameters are determined based at least in part on one or more of location data or network status data associated with the mobile computing device.

At operation 704, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that determines, based at least in part on the one or more configuration parameters, a user interface display theme.

At operation 706, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that determines, based at least in part on the one or more configuration parameters, at least one application instance access permission.

At operation 708 the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that applies the user interface display theme to a user interface associated with the application instance (e.g., the PMS application instance 126).

At operation 710, the PMS computing device 118 includes means such as the processing circuitry 302, the memory 304, the data storage circuitry 306, the input/output circuitry 308, the communication circuitry 310, the electronic displays 312, the cameras 214, the GPS device 316, and/or the like, or a combination thereof, that toggles, based at least in part on the at least one application instance access permission, at least one application instance functionality associated with the application instance (e.g., the PMS application instance 126).

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A computer-implemented method, the computer-implemented method comprising:
generating, by a mobile computing device associated with a production management system (PMS) associated with a first network, at least one first visual indicia associated with one or more portions of testing operation data, wherein the at least one first visual indicia is configured to be displayed via a user interface associated with the mobile computing device;
causing display of the at least one first visual indicia via the user interface, wherein the at least one first visual indicia is configured to be decoded by a scanning device of an isolated diagnostic system (IDS) associated with an isolated network;
decoding a second visual indicia rendered by the IDS, wherein the second visual indicia is associated with a testing data input summary generated by the IDS based on data decoded from the at least one first visual indicia;
generating a third visual indicia associated with a testing data confirmation associated with the testing data input summary; and
causing display of the third visual indicia via the user interface, wherein decoding of the third visual indicia is configured to cause execution of one or more testing operations by the IDS.

2. The computer-implemented method of claim 1, the computer-implemented method further comprising:
decoding a fourth visual indicia rendered by the IDS, wherein the fourth visual indicia is associated with one or more first portions of testing result data generated by the IDS based on the one or more testing operations, and
wherein each portion of the one or more first portions of testing result data is indicated as a key performance characteristic by a classification model of the IDS;
causing, in response to decoding the fourth visual indicia, storage of the one or more first portions of testing result data in a datastore associated with the PMS.

3. The computer-implemented method of claim 2, wherein at least one or more of the at least one first visual indicia, the second visual indicia, the third visual indicia, or the fourth visual indicia are configured as at least one of a quick response (QR) code, a barcode, or a data matrix code.

4. The computer-implemented method of claim 1, the computer-implemented method further comprising:
receiving, during one or more predetermined network connectivity windows, one or more portions of secondary testing result data generated by the IDS based on the one or more testing operations; and
causing storage of the one or more portions of secondary testing result data in a datastore associated with the PMS after receiving the one or more portions of secondary testing result data from the IDS during the one or more predetermined network connectivity windows.

5. The computer-implemented method of claim 4, wherein the one or more portions of secondary testing result data are encrypted by the IDS.

6. The computer-implemented method of claim 4, wherein the one or more predetermined network connectivity windows are associated with a temporary network connection between the first network associated with the PMS and the IDS, and wherein the one or more predetermined network connectivity windows are associated with a predefined transmission duration.

7. The computer-implemented method of claim 4, wherein the IDS is configured to determine at least one or more of a transmission progress, a transmission success, or a transmission failure associated with the one or more portions of secondary testing result data transmitted to the PMS during the one or more predetermined network connectivity windows.

8. The computer-implemented method of claim 1, wherein generating the third visual indicia further comprises:
determining a data validity and a data freshness of one or more portions of data associated with the testing data input summary associated with the second visual indicia;
in response to determining the data validity and the data freshness of one or more portions of data associated with the testing data input summary:
generating the third visual indicia associated with the testing data confirmation.

9. The computer-implemented method of claim 1, wherein the one or more portions of testing operation data comprises at least one or more of product data, machine data, environment data, or at least one testing operation associated with a unit under test (UUT) related to the PMS.

10. An apparatus comprising:
at least one processor; and
at least one non-transitory memory storing instructions that, when executed by the at least one processor, cause the apparatus to:
generate, by a mobile computing device associated with a production management system (PMS) associated with a first network, at least one first visual indicia associated with one or more portions of testing operation data, wherein the at least one first visual indicia is configured to be displayed via a user interface associated with the mobile computing device;
cause display of the at least one first visual indicia via the user interface, wherein the at least one first visual indicia is configured to be decoded by a scanning device of an isolated diagnostic system (IDS) associated with an isolated network;
decode a second visual indicia rendered by the IDS, wherein the second visual indicia is associated with a testing data input summary generated by the IDS based on data decoded from the at least one first visual indicia;
generate a third visual indicia associated with a testing data confirmation associated with the testing data input summary; and
cause display of the third visual indicia via the user interface, wherein decoding of the third visual indicia is configured to cause execution of one or more testing operations by the IDS.

11. The apparatus of claim 10, wherein the instructions, when executed by the at least one processor, further cause the apparatus to:
decode a fourth visual indicia rendered by the IDS, wherein the fourth visual indicia is associated with one or more first portions of testing result data generated by the IDS based on the one or more testing operations, and
wherein each portion of the one or more first portions of testing result data is indicated as a key performance characteristic by a classification model of the IDS;
cause, in response to decoding the fourth visual indicia, storage of the one or more first portions of testing result data in a datastore associated with the PMS.

12. The apparatus of claim 11, wherein at least one or more of the at least one first visual indicia, the second visual indicia, the third visual indicia, or the fourth visual indicia are configured as at least one of a quick response (QR) code, a barcode, or a data matrix code.

13. The apparatus of claim 10, wherein the instructions, when executed by the at least one processor, further cause the apparatus to:
receive, during one or more predetermined network connectivity windows, one or more portions of secondary testing result data generated by the IDS based on the one or more testing operations; and
cause storage of the one or more portions of secondary testing result data in a datastore associated with the PMS after receiving the one or more portions of secondary testing result data from the IDS during the one or more predetermined network connectivity windows.

14. The apparatus of claim 13, wherein the one or more portions of secondary testing result data are encrypted by the IDS.

15. The apparatus of claim 13, wherein the one or more predetermined network connectivity windows are associated with a temporary network connection between the first network associated with the PMS and the IDS, and wherein the one or more predetermined network connectivity windows are associated with a predefined transmission duration.

16. The apparatus of claim 13, wherein the IDS is configured to determine at least one or more of a transmission progress, a transmission success, or a transmission failure associated with the one or more portions of secondary testing result data transmitted to the PMS during the one or more predetermined network connectivity windows.

17. The apparatus of claim 10, wherein the instructions, when executed by the at least one processor, further cause the apparatus to:
determine a data validity and a data freshness of one or more portions of data associated with the testing data input summary associated with the second visual indicia;
in response to determining the data validity and the data freshness of one or more portions of data associated with the testing data input summary:
generate the third visual indicia associated with the testing data confirmation.

18. The apparatus of claim 10, wherein the one or more portions of testing operation data comprises at least one or more of product data, machine data, environment data, or at least one testing operation associated with a unit under test (UUT) related to the PMS.

19. A computer program product comprising at least one non-transitory computer-readable storage medium having computer program code stored thereon that, in execution with at least one processor, is configured to:
generate, by a mobile computing device associated with a production management system (PMS) associated with a first network, at least one first visual indicia associated with one or more portions of testing operation data, wherein the at least one first visual indicia is configured to be displayed via a user interface associated with the mobile computing device;
cause display of the at least one first visual indicia via the user interface, wherein the at least one first visual indicia is configured to be decoded by a scanning device of an isolated diagnostic system (IDS) associated with an isolated network;
decode a second visual indicia rendered by the IDS, wherein the second visual indicia is associated with a testing data input summary generated by the IDS based on data decoded from the at least one first visual indicia;
generate a third visual indicia associated with a testing data confirmation associated with the testing data input summary; and
cause display of the third visual indicia via the user interface, wherein decoding of the third visual indicia is configured to cause execution of one or more testing operations by the IDS.

20. The computer program product of claim 19, wherein the computer program code, in execution with the at least one processor, is further configured to:
decode a fourth visual indicia rendered by the IDS, wherein the fourth visual indicia is associated with one or more first portions of testing result data generated by the IDS based on the one or more testing operations, and
wherein each portion of the one or more first portions of testing result data is indicated as a key performance characteristic by a classification model of the IDS;
cause, in response to decoding the fourth visual indicia, storage of the one or more first portions of testing result data in a datastore associated with the PMS.
